(19) United States
(12) Patent Application Publication
(10) Pub. No.: US 2001/0035076 A1
(43) Pub. Date: Nov. 1, 2001

(54) Slide lock wrench

(76) Inventor: David S. Gilbert JR., Elizabeth, PA (US)

Correspondence Address: DAVID S. GILBERT, JR., 110 ROCK RUN ROAD, ELIZABETH, PA, 15037-2350, US

(21) Appl. No.: 09/809,709

(22) Filed: Mar. 15, 2001

Related U.S. Application Data
(60) Provisional application No. 60/190,436, filed on Mar. 17, 2000.

(51) Int. Cl. B25B 13/22

(52) U.S. Cl. 81/142

(57) ABSTRACT

A quick sliding adjustable locking wrench is disclosed having slidable and movable opposing jaw areas for engaging and gripping hex angular, round, square or irregular workpieces of various sizes within its operating capacity. A quick release jaw mechanism, employed within the wrench, allows the operator of the wrench, rapid release of the jaws from the workpiece, to continue on to the next workpiece engagement. The jaw portions are additionally configured to firmly grip and lock on to the various workpieces.

### BACKGROUND OF THE INVENTION

1. Field of the Invention

This invention relates to wrenches and, more particularly, to wrenches which are usable to handle various types and sizes of hexagonal, square and round work pieces, particularly, nuts, bolts, pipes and pipe fittings.

2. Description of the Prior art

A variety of hand tools have been utilized with the installation of nuts, bolts, pipes and pipe fittings. Wrench—type and plier—type hand tools are commonly used to handle nuts, bolts, pipes and pipe fittings. See, for example, the tools shown in U.S. Pat. Nos. 994,070; 1,027,203; 1,199,806; 2,592,927; 3,968,708; and 3,955,450.

However, the use of these prior art tools to install or remove nuts, bolts, pipes and pipe fittings is disadvantageous for numerous reasons. First, the opposing jaw areas allow a loose application at only two surfaces of the nuts and bolts of various sizes and shapes. In addition, these tools do not provide a uniform holding grip on the nuts or bolts. Further, these tools require a laborious task of repetitious mechanical adjustment and employing the use of various thumb and finger type devices to move the jaws of the tools to encompass the nuts and bolts. The same laborious task of repetitious mechanical adjustment is required to open the jaws to receive the nuts and bolts of various sizes and shapes. In the installation or removal of pipes and pipe fittings, the tools presently in use also require a laborious task of repetitious mechanical adjustment, employing the use of various thumb and finger type devices, to move the jaws of the tools to grasp the various sizes of pipes and pipe fittings. The same laborious task of repetitious mechanical adjustment is also required to open the jaws to receive the pipes and pipe fittings of various sizes and shapes.

Accordingly, it is the object of the present invention to provide wrenches for handling nuts, bolts, pipes and pipe fittings, which can be used to tighten or loosen the nuts, bolts, pipes and pipe fittings, with a uniform holding grip, without the laborious task of repetitious mechanical adjustment. It is another object of the invention to provide wrenches which can be easily used in a confined environment without damage to the nuts, bolts, pipes and pipe fittings themselves.

### SUMMARY OF THE INVENTION

The present invention provides a wrench hand tool for the installation and removal of nuts, bolts, pipes, pipe fittings, rods and bars, with a uniform positive gripping action, without the laborious task of a repetitious mechanical adjustment as required by the wrench-type and plier-type hand tools of prior art.

### BRIEF DESCRIPTION OF THE DRAWINGS

FIG. 1 is a perspective view of the wrench according to the present invention;

FIG. 2 is a perspective view of a second embodiment of the wrench according to the present invention;

FIG. 3 is a front view of the wrench shown in FIG. 1 grasping a hexagon shaped nut;

FIG. 4 is a right side view of the wrench shown in FIG. 3;

FIG. 5 is a left side view of the wrench shown in FIG. 3;

FIG. 6 is a front view of the wrench as shown in FIG. 2 grasping a circular object;

FIG. 7 is a right side view of the wrench shown in FIG. 6;

FIG. 8 is a left side view of the wrench shown in FIG. 6;

FIG. 9 is a front view of a third embodiment of the wrench, grasping a hexagon shaped nut, according to the present invention;

FIG. 10 is a right side view of the wrench shown in FIG. 9;

FIG. 11 is a left side view of the wrench shown in FIG. 9;

FIG. 12 is a front view of a fourth embodiment of the wrench, grasping a hexagon shaped nut, according to the present invention;

FIG. 13 is a right side view of the wrench shown in FIG. 12;

FIG. 14 is a left side view of the wrench shown in FIG. 12;

FIG. 15 is a top view of the wrench shown in FIG. 3;

FIG. 16 is a bottom view of the wrench shown in FIG. 3;

FIG. 17 is a top view of the wrench shown in FIG. 6;

FIG. 18 is a bottom view of the wrench shown in FIG. 6;

FIG. 19 is a top view of the wrench shown in FIG. 9;

FIG. 20 is a bottom view of the wrench shown in FIG. 9;

FIG. 21 is a top view of the wrench shown in FIG. 12;

FIG. 22 is a bottom view of the wrench shown in FIG. 12;

FIG. 23 is a sectional view of FIG. 24;

FIG. 25 is a sectional view of FIG. 26;

FIG. 29 is an enlarged view of FIG. 27 and FIG. 28;

FIG. 30 displays hexagon shaped nuts and pipe fittings of several sizes;

FIG. 31 displays bolts and pipes of several sizes.

### DESCRIPTION OF THE PREFERRED EMBODIMENTS

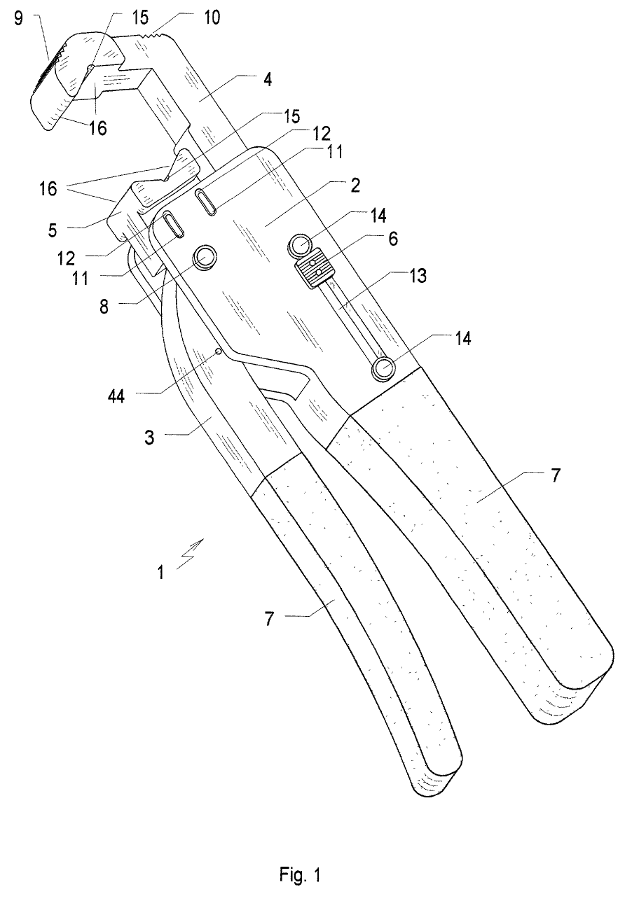

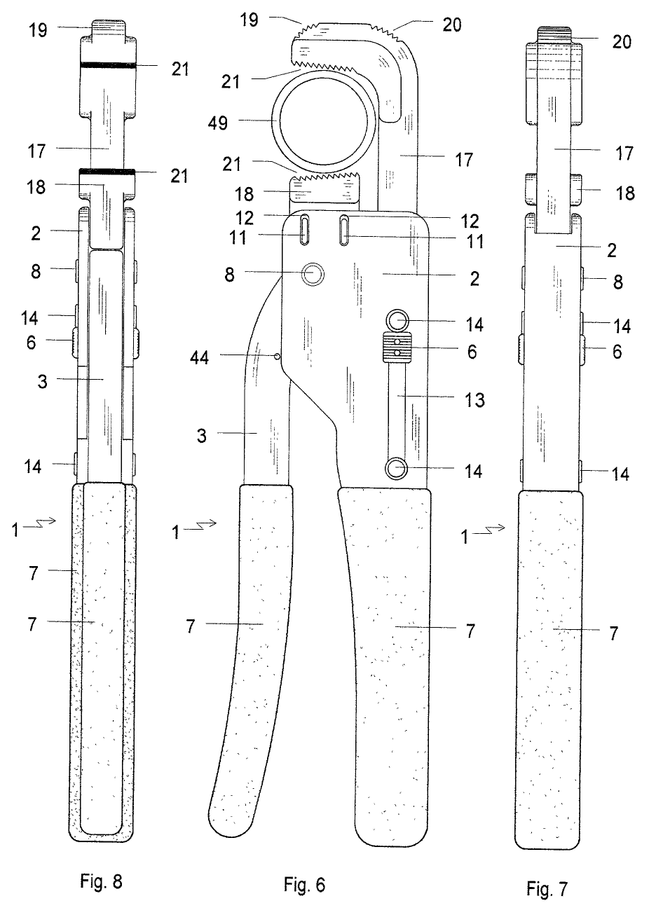

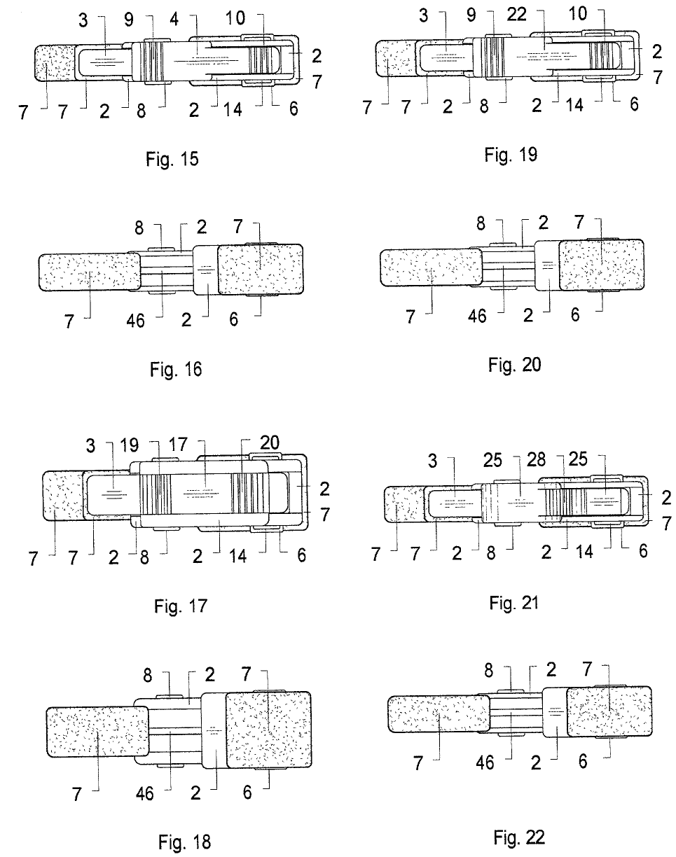

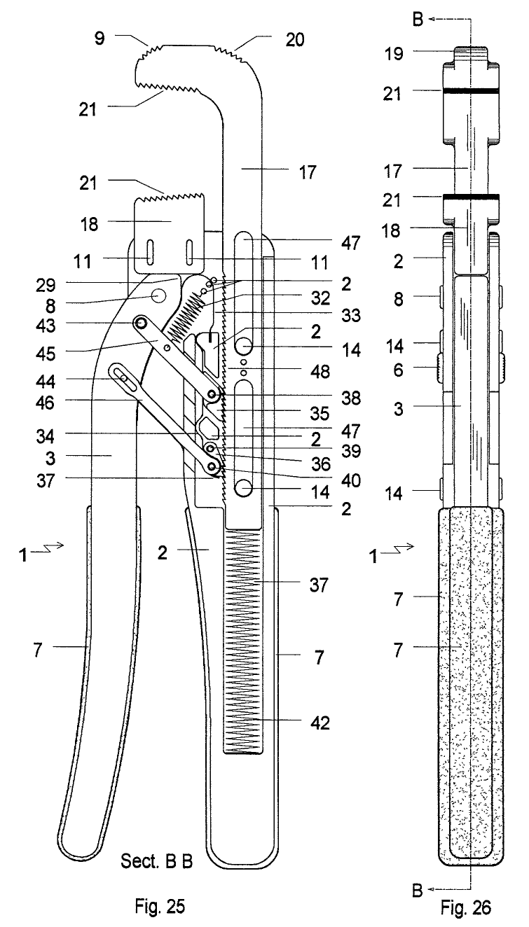

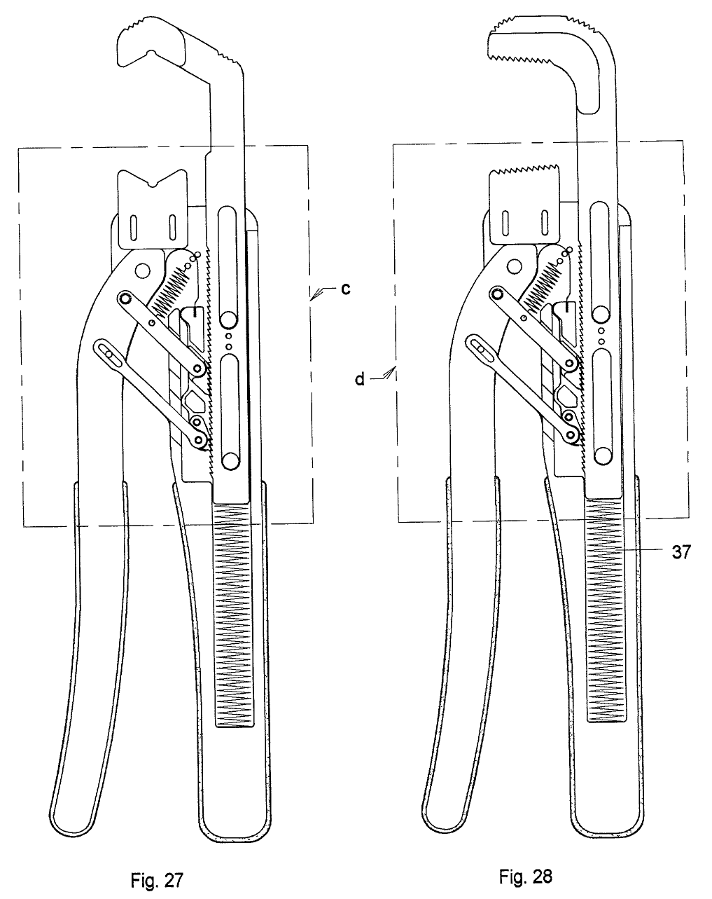

Referring now to FIGS. 1-31, there is shown a wrench 1 for handling hex angular nuts 30 and hex angular bolts 31, as shown in FIGS. 1, 3, 4, 5, 15, 16, 23, 24, 27, 29, 30 and 31. The wrench 1 includes a body 2, a pivoted lever handle 3, an upper flat surfaced angular gripping movable jaw 4, a lower flat surfaced angular gripping movable jaw 5, and a serrated thumb slide 6. The body 2 and the pivoted handle 3 may have plastic or other composition hand grips 7 there about which permit comfortable control of the wrench. The pivoted lever handle 3 is attached to the body 2 by a pivot 8. The angular jaw 4 and the angular jaw 5 are oriented to securely grasp a nut 30 or bolt 31 on four surfaces of the workpiece there between. The wrench 1 may be constructed of drop-forged steel, stamped metal, powdered metal or other adequate strength materials.

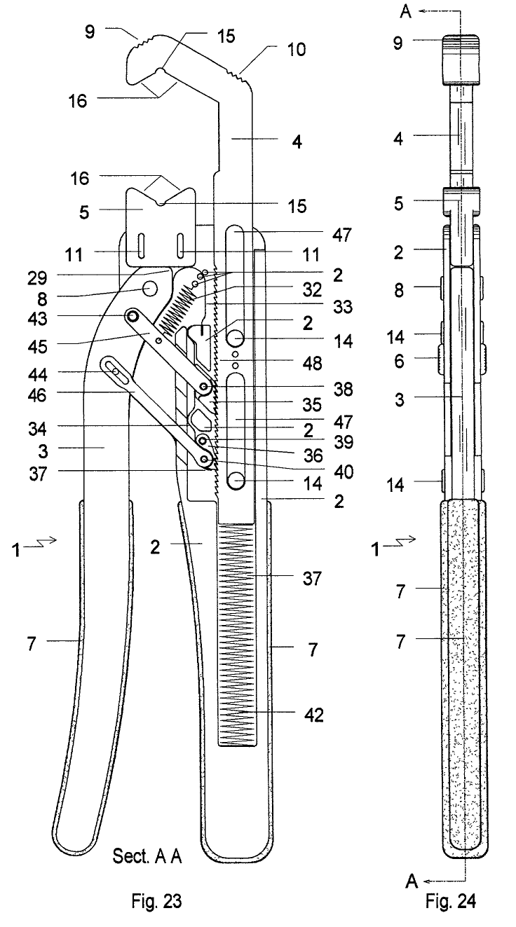

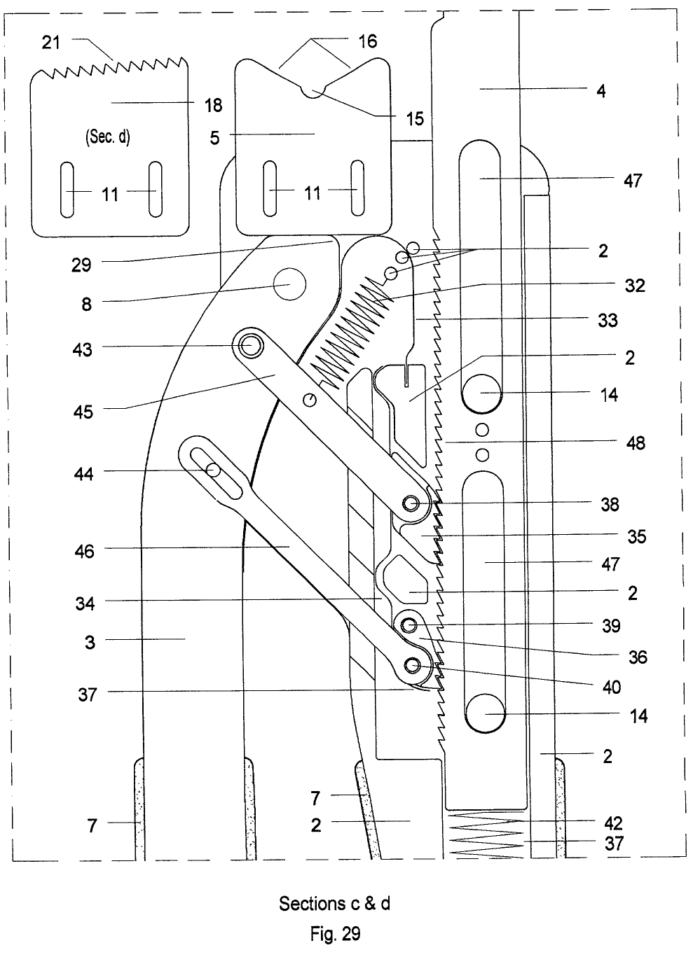

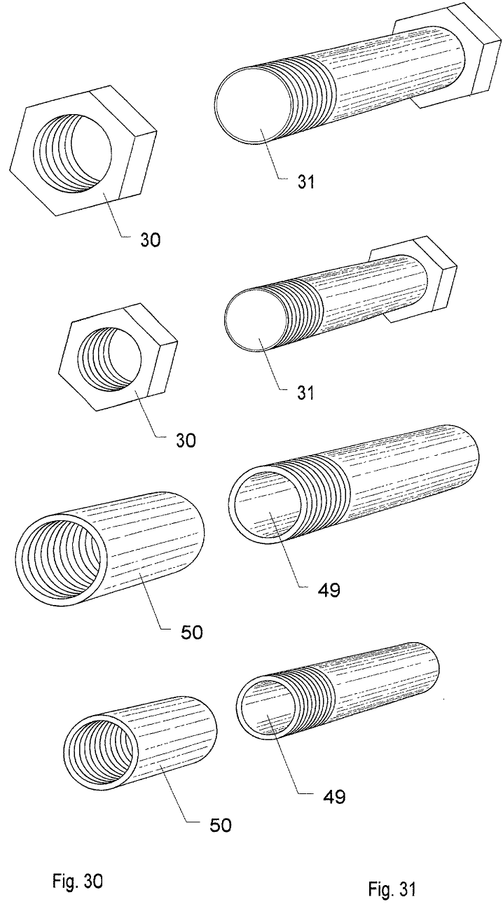

The wrench is usable to tighten or loosen nuts 30 and bolts 31 by moving the jaw 4 toward the jaw 5, thereby grasping the nut 30 or bolt 31 therein. The jaw 4 may be moved toward the jaw 5 by applying force to the jaw 4 on the serrated areas 9 or 10, by sliding the serrated thumb pull 6 or by cranking the handle 3 towards the body 2. Referring to FIGS. 23 and 29, the handle 3 is held in a neutral position by a retaining spring 33. Cranking the handle 3 towards the body 2 causes the pivot 43 to move the link 45 in a downward motion causing the pivoted notched device 35, which is held in constant position against the notched portion 48 of the jaw 4 by the retaining spring 34, to move the jaw 4 to the desired position towards the jaw 5 to engage the nut 30 or bolt 31. Moving the jaw 4 towards the jaw 5 causes the notched dog 36, which is also held in constant position by the retaining spring 34, to engage the notches 48 on the jaw 4 thereby locking the jaw 4 in a positive position.

Grasping the handle 3 toward the body 2, while the jaw 4 is in a locked position, causes a cam lever action at the end portion 29 of the handle 3 against the jaw 5 thereby causing a positive gripping force against the nut 30 or the bolt 31. The nut 30 or bolt 31 may then be rotated clockwise or counterclockwise without inverting the wrench. Releasing the grasp on the handle 3 and moving the handle 3 away from the body 2 beyond the neutral position, allows the pivot pin 44 to move the link 46 away from the body 2 and pulls the pivot pin 40 on the notched dog 36, which revolves on pivot pin 39, thus moving the notched dog 36 away from the notches 48 and simultaneously allows the pivot pin 43 to move the link 45 away from the body 2 and pulls the pivot pin 38 on the notched device 35 thus moving the notched device 35 away from the notches 48 thus allowing the compression spring 42 to return the jaw 4 to a fully open position.

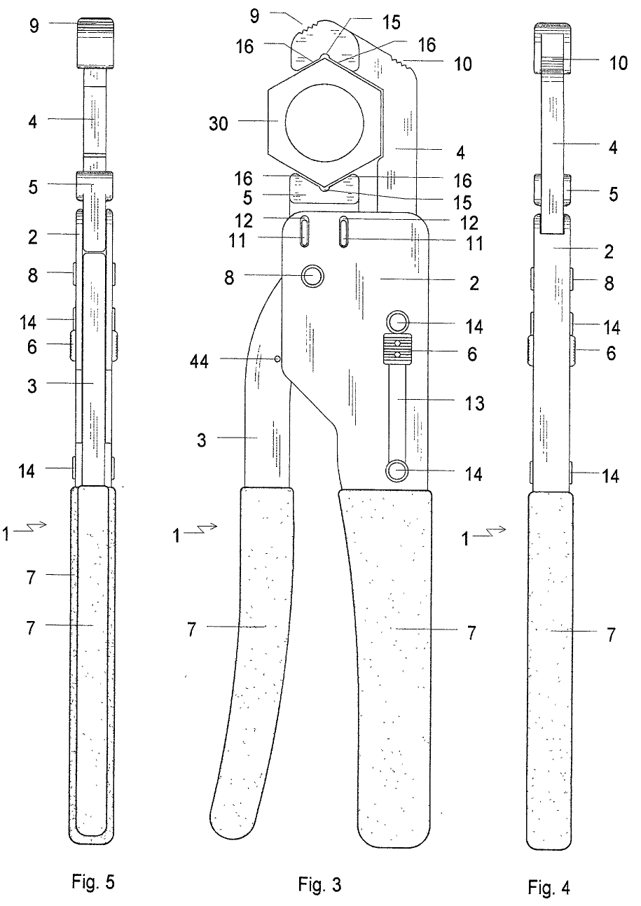

The upper portion of jaws 4 and 5 are formed substantially as hex angular flat gripping surface areas 16, divided by circular grooves 15, to accommodate obtrusive irregularities on the outside comers of some hex angular nuts and bolts. The hex angular flat gripping surface areas 16 are arranged to grasp the angular surfaces of hex angular nuts 30 and bolts 31 as shown in FIGS. 3, 30 and 31. The jaw 5 contains thereon alignment appendages 11 which allows the jaw 5 to move laterally in the alignment slits 12 thus allowing the cam action 29 to tighten the jaw 5 against the nut 30 or bolt 31 as shown in FIG. 3. The jaw 4 contains therein alignment slits 47, which ride along the alignment pins 14 to maintain alignment of the jaw 4 as it travels back and forth in the body pocket chamber 37 as the dog 36 and notched device 35 engage or disengage the notches 48 on the jaw 4 as shown in FIGS. 23, 27 and 29. The lower body portion contains therein a body chamber 37 to house a coil spring 42 to maintain constant pressure against the lower portion of jaw 4 as shown in FIGS. 23, 27 and 29.

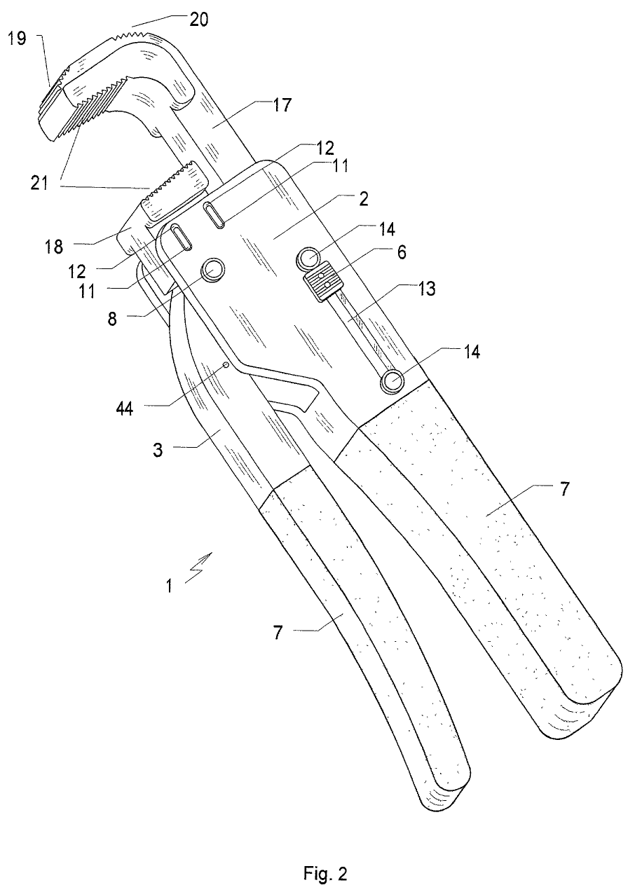

The first preferred embodiment of the wrench is fully described above. A second preferred embodiment of the wrench 1 for handling pipes 49 and pipe fittings 50 is shown in FIGS. 2, 6, 7, 8, 17, 18, 25, 26, 28 and 29, 30 and 31. The wrench 1 includes a body 2, a pivoted lever handle 3 and serrated gripping surfaces 21 on jaws 17 and 18 for grasping pipes 49 and pipe fittings 50. The wrench is usable to tighten or loosen pipes 49 and pipe fittings 50 by moving the jaw 17 toward the jaw 18, thereby grasping the pipes 49 and pipe fittings 50 therein. The jaw 17 may be moved toward the jaw 18 by applying force to the jaw 17 on the serrated areas 19 or 20, by sliding the serrated thumb pull 6 or by cranking the handle 3 towards the body 2. When the jaws 17 and 18 engage the pipe 49 or pipe fitting 50, grasping the handle 3 towards the body 2 causes the cam lever action at the end portion 29 thereby causing a positive tightening of the jaw 18 against the jaw 17 thus causing a positive gripping force on the pipe 49 or pipe fitting 50. Releasing the grasp on the handle 3, allows the wrench to rotate on the pipe 49 or fitting 50 in a repetitive manner without removing the wrench from the workpiece. Removing the pipes 49 and pipe fittings 50 is accomplished by inverting the wrench on the pipes 49 and pipe fittings 50 and rotating the wrench in a counterclockwise direction thus removing the workpiece.

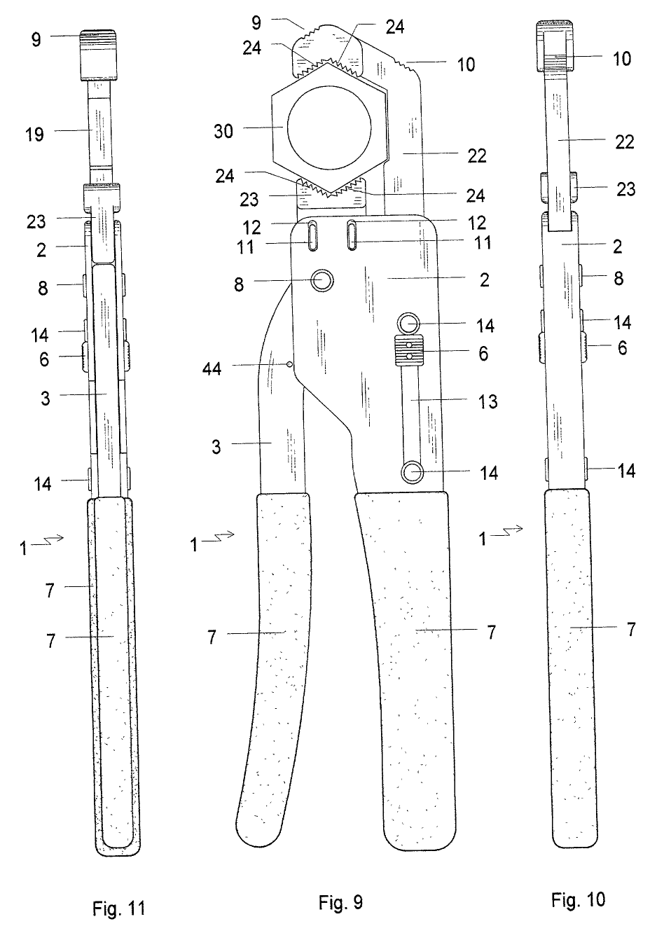

A third preferred embodiment of the wrench 1 for handling hex angular nuts is shown in FIGS. 9, 10, 11, 19, 20, 30 and 31. The wrench includes a body 2, a pivoted lever handle 3, serrated angular gripping surfaces 24 on movable jaws 22 and 23 for grasping damaged or irregular shaped objects such as, but not limited to, nuts, bolts, pipes, fittings, rods and bars. The wrench is usable to tighten or loosen workpieces by moving the jaw 22 toward the jaw 23, thereby grasping the workpiece therein. The jaw 22 may be moved toward the jaw 23 by applying force to the jaw 22 on the serrated areas 9 or 10, by sliding the serrated thumb pull 6, or by cranking the handle 3 towards the body 2. When the jaws 22 and 23 engage the workpiece, grasping the lever handle 3 towards the body 2 causes a cam lever action at the end portion 29 against jaw 24 thereby causing a positive gripping force against the workpiece. The workpiece may then be rotated clockwise or counterclockwise without inverting the wrench.

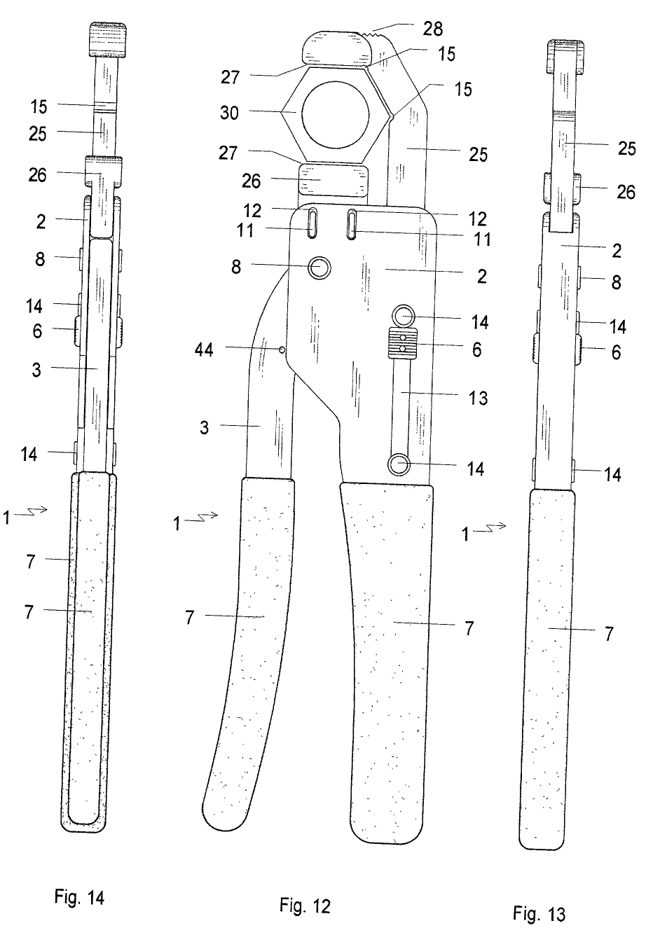

A fourth preferred embodiment of the wrench 1 for handling hex angular and square nuts as shown in FIGS. 12, 13, 14, 21, 22, 30 and 31. The wrench 1 includes a body 2, a pivoted lever handle 3, opposing parallel aligned flat gripping surfaces 27 on movable jaws 25 and 26 for grasping hex angular and square nuts. The wrench is usable to tighten or loosen workpieces by moving the jaw 25 toward the jaw 26, thereby grasping the workpiece therein. The jaw 25 may be moved toward the jaw 26 by applying force to the jaw 25 on the serrated area 28, by sliding the serrated thumb pull 6, or by cranking the handle 3 towards the body 2. When the jaws 25 and 26 engage the workpiece, grasping the handle 3 towards the body 2 causes the cam lever action at the end portion 29 against jaw 26 thereby causing a positive gripping force against the workpiece. The workpiece may then be rotated clockwise or counterclockwise without inverting the wrench.

Having described above the presently preferred embodiments of the present invention, it is to be understood that the invention may be otherwise embodied within the scope of the appended claims.

I claim:

1. A hand tool for handling a work piece, comprising:
a body portion having therein an adjustable upper flat surfaced angular slidable jaw portion oriented to securely grasp a workpiece therein, having provided thereon an extended member containing an outer side surface of ratcheted teeth, and a spring actuated notched dog pivoted in a body chamber to engage said ratcheted teeth and means for holding said upper flat surfaced angular slidable jaw portion in a cooperative position;
an opposing lower flat surfaced angular movable jaw portion in said body portion thereof, oriented to securely grasp said workpiece therein; and
a pivoted lever handle therein, having thereon a cam shaped end, held in a neutral position in said body chamber by a retaining spring, when grasped and moved towards said body in a cranking motion, moves a connected link held in tension by a spring in said body chamber, in a downward position causing a second connected pivoted notched device in said body chamber, held in constant position by a retaining spring in said body chamber, to engage said teeth of said upper flat surfaced angular slidable jaw portion to move said upper flat surfaced angular slidable jaw portion to a desired position towards said opposing lower flat surfaced angular movable jaw
portion thereby engaging said workpiece firmly between said opposing upper and lower jaws; and
said cam action means on said lever handle cam shaped end, urges said lower flat surfaced angular movable jaw portion to exert positive gripping force on said workpiece therein; and releasing said grasp on said lever handle and moving said lever handle away from said body beyond said neutral position, releases said spring actuated pivoted notched dog and said pivoted notch device away from said upper flat surfaced angular slidable jaw notches allowing a compression spring means in said body chamber to move said upper flat surfaced angular slidable jaw portion away from said workpiece and said opposing lower flat surfaced angular
movable jaw portion to a fully open position whereby allowing the operator of said hand tool means to disengage said hand tool from said workpiece quickly to engage other workpieces of various sizes.

2. The hand tool of claim 1 wherein said workpieces may be hex nuts having obtrusive irregularities at the intersections of its hex-angular surfaces, whereby a groove is adapted at the intersection of the inner surfaces of the said upper flat surfaced angular slidable jaw portion and said lower flat surfaced angular movable jaw portion to receive said obtrusive irregularities of said workpiece on said jaw gripping areas.

3. The hand tool of claim 1 wherein said adjustable upper flat surfaced angular slidable jaw portion contains thereon serrated areas on the outer surfaces means to apply force to move said upper flat surfaced angular slidable jaw portion towards said lower flat surfaced angular movable jaw portion to engage said workpiece firmly between said upper and lower jaws.

4. The hand tool of claim 1 wherein said adjustable upper flat surfaced angular slidable jaw portion contains thereon serrated thumb pulls means for applying force to move said upper flat surfaced angular slidable jaw portion towards said lower flat surfaced angular movable jaw portion to engage said workpiece firmly between said upper and lower jaws.

5. The hand tool of claim 1 wherein said lower flat surfaced angular movable jaw portion contains thereon alignment appendages means to allow said lower flat surfaced angular movable jaw portion to move laterally in alignment slits in said body allowing said cam action means to exert said positive gripping force on said workpiece therein.

6. The hand tool of claim 1 wherein pivot pins means connect said links to said pivoted lever handle, said notched dog and said notched device.

7. The hand tool of claim 1 wherein pivot pin means connect said pivoted lever handle to said body.

8. The hand tool of claim 1 wherein body pins means allow said upper flat surfaced angular slidable jaw portion to move laterally with alignment slits therein.

9. The hand tool of claim 1 wherein said workpieces may be pipes and pipe fittings, whereby said upper flat slidable jaw portion and opposing said lower flat movable jaw portion have slanted serrated gripping surface means for handling round workpieces.

10. The hand tool of claim 1 wherein said workpieces may be damaged or irregular in shape, whereby said upper angular slidable jaw portion and opposing said lower angular movable jaw portion have serrated gripping surface means for handling said workpieces.

11. The hand tool of claim 1 wherein said workpieces may be hex angular or square, whereby said upper slidable jaw portion and opposing said lower movable jaw portion have flat gripping surface means for handling said workpieces.
